(19) United States
(12) Patent Application Publication
(10) Pub. No.: US 2025/0088821 A1
(43) Pub. Date: Mar. 13, 2025

(54) SYSTEM AND INFORMATION PROCESSING DEVICE

(71) Applicant: TOYOTA JIDOSHA KABUSHIKI KAISHA, Aichi-ken (JP)

(72) Inventors: Koki MORI, Toyota-shi (JP); Takashi AKIMOTO, Toyota-shi (JP)

(21) Appl. No.: 18/755,677

(22) Filed: Jun. 27, 2024

(30) Foreign Application Priority Data
Sep. 13, 2023 (JP) 2023-148767

(51) Int. Cl. H04W 4/021; G01S 1/04; H04W 4/44

(52) U.S. Cl. CPC H04W 4/021; G01S 1/042; H04W 4/44

(57) ABSTRACT

A system comprising a vehicle and a server. The vehicle includes a first control unit configured to, when detecting a beacon from a beacon transmitter disposed on a road, notify the server that the beacon has been detected in response to the engine of the vehicle being stopped. The server includes a second control unit configured to, in response to receiving a notification that a beacon has been detected from the vehicle, determine whether the vehicle has passed a predetermined point, and in response to determining that the vehicle has passed the predetermined point, notify an administrator of the vehicle that the vehicle has passed the predetermined point.

### CROSS-REFERENCE TO RELATED APPLICATION

This application claims priority to Japanese Patent Application No. 2023-148767 filed on Sep. 13, 2023, incorporated herein by reference in its entirety.

### BACKGROUND

### 1. Technical Field

The present disclosure relates to a system and an information processing device.

### 2. Description of Related Art

Japanese Unexamined Patent Application Publication No. 2012-066648 (JP 2012-066648 A) discloses that position information of a vehicle is periodically acquired when the engine of the vehicle is stopped and, when the position of the vehicle is different from the position of the vehicle acquired last time by a predetermined distance or more, a predetermined signal is transmitted to a facility external to the vehicle.

### SUMMARY

An object of the present disclosure is to provide a technology for giving a notification about a position of a vehicle while suppressing an increase in power consumption.

One aspect of the present disclosure provides a system including:
a vehicle; and
a server.

The vehicle includes a first control unit configured to, when a beacon from a beacon transmitter disposed on a road is detected, notify the server that the beacon is detected in response to a stop of an engine of the vehicle.

The server includes a second control unit configured to:
determine whether the vehicle has passed a predetermined point in response to reception of a notification from the vehicle that the beacon is detected; and
notify a manager of the vehicle that the vehicle has passed the predetermined point in response to determination that the vehicle has passed the predetermined point.

Alternatively, one aspect of the present disclosure provides an information processing device including a control unit configured to, when a beacon from a beacon transmitter disposed on a road is detected, transmit information on the beacon to an external server in response to a stop of an engine of a vehicle.

Other aspects of the present disclosure relate to an information processing method that causes a computer to execute the above information processing, a program that causes the computer to execute the information processing method, and a computer-readable storage medium that non-transitorily stores the program.

According to the present disclosure, it is possible to provide the technology for giving the notification about the position of the vehicle while suppressing the increase in the power consumption.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment;

FIG. 2 is a block diagram schematically illustrating an example of a configuration of each of a vehicle and a server constituting the system according to the embodiment;

FIG. 3 is a diagram illustrating an exemplary table configuration of a vehicle information DB according to the embodiment;

FIG. 4 is a flow chart illustrating a process in vehicles; and

FIG. 5 is a flowchart illustrating processing in the server.

### DETAILED DESCRIPTION OF EMBODIMENTS

It is conceivable to periodically transmit position information when the engine of the vehicle is stopped. The position of the vehicle can then be tracked, for example when the vehicle is stolen. However, when the engine is stopped, if the position information is periodically transmitted, the remaining charge of the battery may be insufficient.

In order to solve such a problem, a system according to an aspect of the present disclosure includes a vehicle and a server. The vehicle includes a first control unit. When detecting a beacon from a beacon transmitter disposed on a road, the first control unit notifies the server that the beacon has been detected in response to the stop of the engine of the vehicle. The beacon transmitter transmits the beacon using, for example, a radio LAN or near field communication. The power consumption for the vehicle to receive this beacon is relatively low. Here, for example, when the position data is acquired by GPS receiver, power is consumed more than when the beacon is received. Therefore, if the position data is acquired by GPS receiver while the power supply is stopped, the remaining charge of the battery may be insufficient. On the other hand, if the position information is acquired by receiving the beacon, it is possible to suppress insufficient remaining charge of the battery even when the engine is stopped. The position information included in the beacon may be transmitted from the vehicles to the servers, or a beacon ID that is identification information unique to the beacon included in the beacon may be transmitted.

Further, the server includes a second control unit. The second control unit determines whether or not the vehicle has passed a predetermined point in response to receiving a notification indicating that the beacon has been detected from the vehicle. The predetermined point is, for example, a point within a predetermined distance from the boundary line of the geofence set by the administrator of the vehicle. For example, the second control unit may compare the information on the geofence stored in the storage unit with the position information received from the vehicle to determine whether or not the vehicle has passed a predetermined point. Then, in response to determining that the vehicle has passed the predetermined point, the second control unit notifies the administrator of the vehicle that the vehicle has passed the predetermined point. The administrator of the vehicle may be the owner of the vehicle. The administrator of the vehicle receives a notification from the server, for example, when the vehicle enters the geofence or when the vehicle exits the geofence. Therefore, the administrator can know the rough position of the vehicle.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

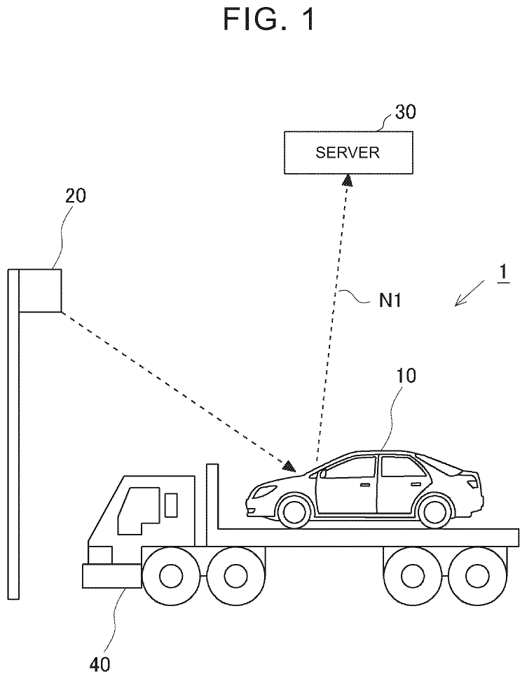

FIG. 1 is a schematic diagram of a system 1 according to an embodiment. In the example of FIG. 1, the system 1 includes a vehicle 10, a beacon transmitter 20, and a server 30. The vehicle 10 is a vehicle equipped with an engine. The vehicle 10 is mounted on a loading platform of the vehicle carrier 40 in a state where the engine is stopped. The vehicle carrier 40 is a vehicle that is movable in a state in which the vehicle 10 is mounted. FIG. 1 exemplarily illustrates one vehicle 10, but the present disclosure is not limited to this, and there are a plurality of vehicles 10. The vehicle carrier 40 may also carry a plurality of vehicles 10. There are also a plurality of beacon transmitters 20. The vehicle 10 and the server 30 are connected together via a network N1. Note that the network N1 may be, for example, a global public communication network such as the Internet, and Wide Area Network (WAN) or another communication network may be adopted. In addition, the network N1 may include a telephone communication network such as a mobile phone network and a wireless communication network such as Wi-Fi (registered trademark).

The beacon transmitter 20 is located on the street and transmits the location of the beacon transmitter 20 using a wireless communication such as Wi-Fi, or a short-range wireless communication such as Bluetooth or Bluetooth Low Energy (BLE). When the vehicle 10 receives the position information from the beacon transmitter 20 while the engine is stopped, it transmits the beacon information including the position information to the server 30 in association with the vehicle ID. Upon receiving the beacon information from the vehicle 10, the server 30 provides the information to the administrator of the vehicle 10 in accordance with the beacon information. For example, by arranging the beacon transmitter 20 on each road passing through the boundary line of the predetermined area, it is possible to notify the administrator of the vehicle 10 that the vehicle 10 enters the predetermined area or that the vehicle 10 exits from the predetermined area.

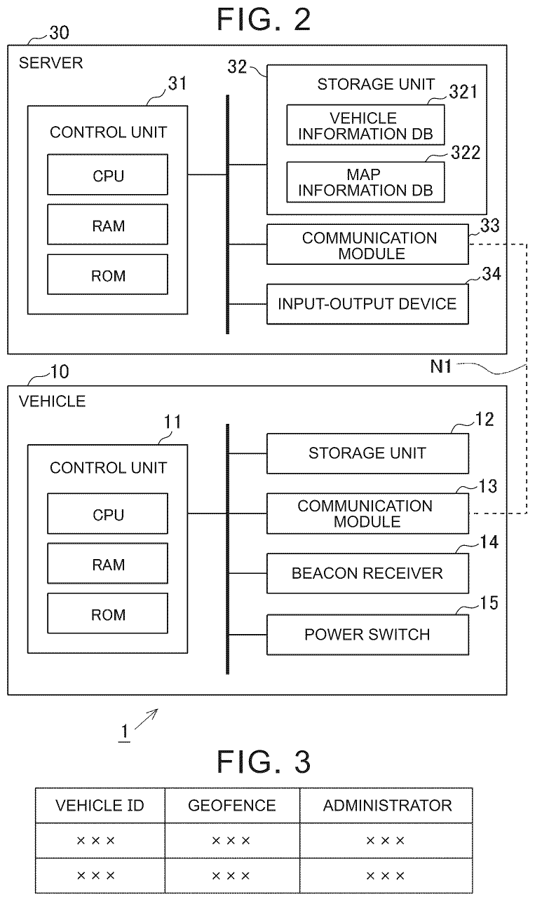

FIG. 2 is a block diagram schematically showing an example of the configuration of each of the vehicle 10 and the server 30 constituting the system 1 according to the present embodiment. The server 30 includes a control unit 31, a storage unit 32, a communication module 33, and an input/output device 34. The control unit 31 is an example of a second control unit.

The server 30 can be configured as a computer including a processor (such as a CPU, GPU), a main storage device (such as a RAM, ROM), and a secondary storage device (such as a EPROM, a hard disk drive, and a removable medium). The secondary storage device stores an operating system (OS), various programs, various tables, and the like, and by executing the programs stored therein, it is possible to realize functions (software modules) that meet predetermined objectives, as will be described later. However, some or all of the modules may be realized as hardware modules by, for example, hardware circuitry such as a ASIC, FPGA.

The control unit 31 is an arithmetic unit that realizes various functions of the server 30 by executing a predetermined program. The control unit 31 can be realized by, for example, a hardware processor such as a CPU. In addition, the control unit 31 may be configured to include a RAM, Read Only Memory (ROM), a cache memory, and the like. Details of the control unit 31 will be described later.

The storage unit 32 is a unit that stores information, and is configured by a storage medium such as a RAM, a magnetic disk, or a flash memory. The storage unit 32 stores a program executed by the control unit 31, data used by the program, and the like. In addition, a database (vehicle information DB 321 and map information DB 322) is constructed in the storage unit 32, and vehicle information and map information, which are information about the respective vehicles 10, are stored in the database.

FIG. 3 is a diagram illustrating an exemplary table configuration of a vehicle information DB 321 according to the embodiment. The vehicle information DB 321 stores information related to the geofence and information related to the administrator in association with the vehicle ID. The vehicle ID is identification information unique to the vehicle 10. The information related to the geofence is information related to an area to be notified when the vehicle 10 comes in and out. Information on the geofence is input by, for example, an administrator of the vehicle 10 via a terminal of the administrator. For example, the control unit 31 displays a map on the administrator's terminal, and the administrator designates the center point of the circle and the radius of the circle displayed on the map via the terminal, so that the geofence can be set. The circle becomes a virtual boundary line, and a region surrounded by the circle becomes a geofence region. The information regarding the administrator is information necessary for notifying the administrator of the vehicle 10 of the position of the vehicle 10. The information about the administrator includes information used when the control unit 31 notifies the administrator, such as information about a telephone number, an e-mail address, a social media account, and a push notification.

Further, the map information DB 322 stores, as map information, for example, link data relating to a road (link), node data relating to a node point, intersection data relating to each intersection, search data for searching a route, section data relating to a section, information relating to the position of the beacon transmitter 20, and the like.

The communication module 33 is a communication interface for connecting the server 30 to the network N1. The communication module 33 may be configured to include, for example, a network interface board, a wireless communication interface for wireless communication, and the like. The server 30 can perform data communication with each vehicle 10 via the communication module 33.

The input/output device 34 is a means for receiving an input operation performed by an operator and presenting information to the operator. Specifically, the input/output device 34 includes a device for inputting a mouse, a keyboard, or the like, and a device for outputting a display, a speaker, or the like. The input/output device 34 may be integrally formed of, for example, a touch panel display or the like.

Note that the specific hardware configuration of the server 30 can be omitted, replaced, or added as appropriate depending on the embodiment.

Next, the vehicle 10 will be described. The vehicle 10 includes a control unit 11, a storage unit 12, a communication module 13, a beacon receiver 14, and a power switch 15. The control unit 11 is an arithmetic unit that realizes various functions of the vehicle 10 by executing a predetermined program. The control unit 11 can be realized by, for example, a hardware processor such as a CPU. In addition, the control unit 11 may be configured to include a RAM, Read Only Memory (ROM), a cache memory, and the like. The control unit 11 is an example of a first control unit.

The storage unit 12 is a unit that stores information, and is configured by a storage medium such as a RAM, a magnetic disk, or a flash memory. The storage unit 12 stores a program executed by the control unit 11, data used by the program, and the like.

The communication module 13 is a communication unit for connecting the vehicles 10 to the network N1. In the present embodiment, vehicles 10 can communicate with other devices (for example, server 30) over a network N1 using a mobile communication service such as 3G, LTE, 5G, 6G.

The beacon receiver 14 is a device that receives a beacon from the beacon transmitter 20. For example, the beacon receiver 14 may receive the beacon using a wireless communication such as Wi-Fi, or a short-range wireless communication such as Bluetooth, or Bluetooth Low Energy (BLE).

The power switch 15 is a switch for operating or stopping the engine of the vehicle 10, and is a switch for starting the engine of the vehicle 10 or stopping the engine of the vehicle 10 when the driver presses the switch. A state in which the driver presses the power switch 15 and the engine is operating is referred to as a IG on state, and a state in which the user presses the power switch 15 again and the engine is stopped is referred to as a IG off state. The power switch 15 may be a IG switch.

The control unit 11 of the vehicle 10 can receive the beacon via the beacon receiver 14 even when IG is off. When IG is off and the beacon is received, the control unit 11 transmits the beacon data to the servers 30. The beacon information includes a vehicle ID and position information included in the beacon. In this situation, the beacon receiver 14 operates even in IG off-state, but the power consumed by the beacon receiver 14 is low, so that the amount of reduction in the remaining charge of the battery is relatively small. Therefore, the remaining charge of the battery is suppressed from becoming 0.

Since the vehicle 10 is transported to the vehicle carrier 40 even when IG is off, the vehicle may exit the geofence or enter the geofence. Each time a beacon transmitted from the beacon transmitter 20 disposed on the road is received, the control unit 11 of the vehicle 10 transmits the position information included in the beacon to the server 30 in association with the vehicle ID. When IG is on, the control unit 11 of the vehicle 10 may or may not transmit the position information included in the beacon. In other words, the position data included in the beacon may be transmitted at least when IG is off.

Further, the control unit 31 of the server 30 determines whether or not the vehicle 10 has passed the boundary line of the geofence based on the position information acquired from the vehicle 10. Upon receiving the beacon information from the vehicle 10, the control unit 31 extracts the vehicle ID included in the beacon information. Then, a record corresponding to the vehicle ID is identified from the vehicle information DB 321. Further, information on the geofence is extracted from the record and compared with the position information included in the beacon information. For example, if the position of the vehicle 10 specified by the position information is within a predetermined distance from the geofence, it is determined that the vehicle 10 has passed the boundary line of the geofence. That is, the control unit 31 determines that the vehicle 10 has entered or exited the geofence. In response to determining that the vehicle 10 has passed the boundary line of the geofence, the control unit 31 notifies the administrator of the vehicle 10 that the vehicle 10 has passed the boundary line of the geofence. Information about the administrator of the vehicle 10 is extracted from the corresponding record of the vehicle information DB 321.

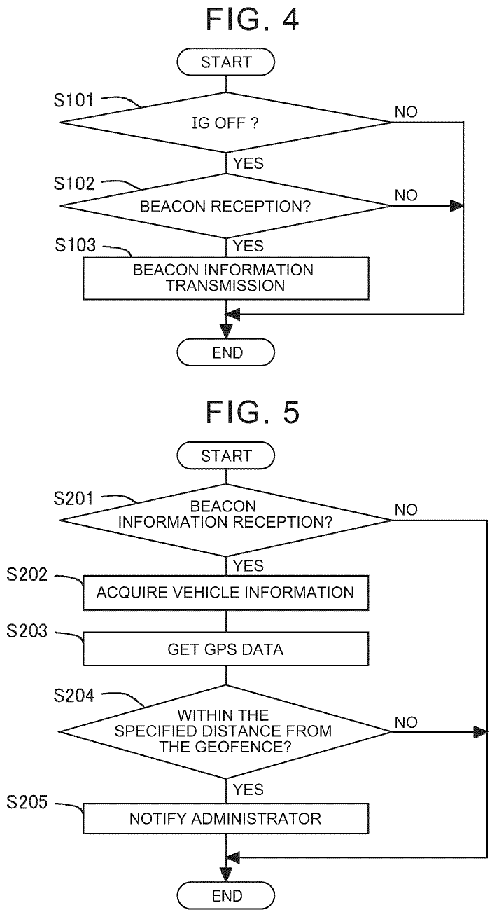

Next, a process in the vehicle 10 will be described. FIG. 4 is a flowchart illustrating processing in the vehicle 10. In S101, the control unit 11 determines whether or not the vehicles 10 are IG off-state. As another example, it may be determined whether or not the engine of the vehicle 10 is in a stopped state. If an affirmative determination is made in S101, the process proceeds to S102, and if a negative determination is made, the routine ends.

In S102, the control unit 11 determines whether or not a beacon is received from the beacon transmitter 20. If an affirmative determination is made in S102, the process proceeds to S103, and if a negative determination is made, the routine ends. In S103, the control unit 11 transmits the position information included in the beacon to the server 30 in association with the vehicle ID. At this time, the control unit 11 may activate the minimum necessary system for transmitting the beacon information. After the beacon information is transmitted, the system may be stopped.

Next, processes in the server 30 will be described. FIG. 5 is a flowchart illustrating processing in the server 30. The flowchart illustrated in FIG. 5 is executed in the server 30 at predetermined time intervals. It is assumed that vehicle information corresponding to a plurality of vehicles 10 is stored in the vehicle information DB 321.

In S201, the control unit 31 determines whether or not the beacon data has been received from the vehicles 10. If an affirmative determination is made in S201, the process proceeds to S202, and if a negative determination is made, the routine ends.

In S202, the control unit 31 extracts the vehicle information of the target vehicle 10 from the vehicle information DB 321. At this time, the control unit 31 extracts a record corresponding to the vehicle ID included in the beacon information from the vehicle information DB 321. Further, in S203, the control unit 31 acquires the position information from the beacon information. In S204, the control unit 31 determines whether or not the position of the vehicle 10 is within a predetermined distance from the geofence. The predetermined distance is a distance that may be considered to have passed through a boundary line of the geofence. As another example, the geofence may be set to link the position of the beacon transmitter 20. That is, the beacon transmitter 20 may be on the boundary of the geofence. In this case, the control unit 31 may determine whether or not the beacon information includes the position information transmitted from the beacon transmitter 20 on the boundary line of the geofence. If an affirmative determination is made in S204, the process proceeds to S205, and if a negative determination is made, the routine ends.

In S205, the control unit 31 notifies the administrator of the vehicle 10 that the vehicle 10 has passed the border line of the geofence. The administrator is an administrator associated with the vehicle ID in the vehicle information DB 321. At this time, the administrator may be notified of the vehicle ID.

As described above, according to the present embodiment, even when the vehicle 10 is being transported by the vehicle carrier 40, the vehicle 10 can transmit the position information received from the beacon transmitter 20 disposed on the road to the server 30. For the reception of the beacon, for example, a short-range wireless communication with low power consumption is used, so that it is possible to prevent the remaining charge amount of the battery of the vehicle 10 from being excessively reduced. In addition, when the vehicle 10 enters the geofence or exits the geofence, the administrator of the vehicle 10 is notified of this fact, so that the administrator can know the rough position of the vehicle 10.

### OTHER EMBODIMENTS

The above embodiments are only examples, and the disclosure may be carried out with various modifications without departing from the essence thereof. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The vehicles 10 may transmit, to the server 30, a beacon ID which is identification information unique to the beacon transmitter 20 instead of the location information. If the relation between the beacon ID and the positional information of the beacon transmitter 20 is stored in the storage unit 32, the positional information of the vehicles 10 can be acquired from the beacon ID. Further, the control unit 31 of the server 30 may notify the administrator of the vehicle 10 of the route traveled by the vehicle 10 based on the history of the beacon information received from the vehicle 10.

The disclosure can also be implemented by providing a computer program in which the functions described in the embodiments are implemented to a computer, and by one or more processors included in the computer reading and executing the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. A system comprising:
a vehicle; and
a server, wherein
the vehicle includes a first control unit configured to, when a beacon from a beacon transmitter disposed on a road is detected, notify the server that the beacon is detected in response to a stop of an engine of the vehicle, and
the server includes a second control unit configured to:
determine whether the vehicle has passed a predetermined point in response to reception of a notification from the vehicle that the beacon is detected; and
notify a manager of the vehicle that the vehicle has passed the predetermined point in response to determination that the vehicle has passed the predetermined point.

2. The system according to claim 1, wherein the predetermined point is a point within a predetermined distance from a boundary line of a geofence set by the manager of the vehicle.

3. The system according to claim 1, wherein the server includes a storage unit configured to store identification information unique to the vehicle, information on a geofence set by the manager of the vehicle, and information on the manager of the vehicle.

4. An information processing device comprising a control unit configured to, when a beacon from a beacon transmitter disposed on a road is detected, transmit information on the beacon to an external server in response to a stop of an engine of a vehicle.
